(19) United States
(12) Patent Application Publication
(10) Pub. No.: US 2023/0184940 A1
(43) Pub. Date: Jun. 15, 2023

(54) MEASUREMENT UNIT, AND MEASUREMENT APPARATUS AND METHOD

(71) Applicant: NINGBO ABAX SENSING CO., LTD., Ningbo City (CN)

(72) Inventor: Shuyu LEI, Ningbo City, Zhejiang Province (CN)

(73) Assignee: Ningbo ABAX Sensing Electronic Technology Co., Ltd., Ningbo City (CN)

(21) Appl. No.: 17/924,528

(22) PCT Filed: Jun. 22, 2020
(86) PCT No.: PCT/CN2020/097333

§ 371 Date: Nov. 10, 2022

(30) Foreign Application Priority Data
May 13, 2020 (CN) 202010403265.1

(51) Int. Cl. G01S 17/32; G01S 7/481; G01S 7/4915; H04N 25/704

(52) U.S. Cl. CPC G01S 17/32; G01S 7/4816; G01S 7/4915; H04N 25/704

(57) ABSTRACT

A measurement pixel unit, and a measurement apparatus and a measurement method using same. The measurement apparatus comprises a light source that can be operated to emit light so as to illuminate a measured object; a photosensitive module may output an electrical signal by means of a first circuit receiving a first modulation signal and a second circuit receiving a second modulation signal; a processing module may receive different control signals to perform control, and thus may work at different modes in a measurement system; the two circuits can separately output the electrical signal corresponding to the phase delay of one of delay phase reception control signals, thereby achieving the accuracy of measurement information; moreover, the system further can perform reasonable arrangement on phase delay information and exposure duration information in a sub frame at a certain frame rate mode, thereby ensuring the high efficiency of the whole system.

### CROSS REFERENCE TO RELATED APPLICATIONS

The present application claims priority to Chinese Patent Application No. CN202010403265.1, titled “MEASUREMENT UNIT, AND MEASUREMENT APPARATUS AND METHOD”, filed on May 13, 2020 with the Chinese Patent Office, which is incorporated herein by reference in its entirety.

### FIELD

The present disclosure relates to the field of detection technology, and in particular to a detection unit, a detection device and a detection method.

### BACKGROUND

In the field of detection technology, more and more technologies are continuously developed. In order to ensure that a target in an application field such as the image acquisition or the distance measurement can be detected efficiently and fast, more and more devices are designed to have a multi-tap (two or more than two) structure, which may work in different time periods to read photo-generated electrons generated in a connected pixel unit. In the case that the multi-tap is reasonably arranged, the photosensitive module in the chip or formed by the multi-tap can efficiently work. However, there is a deviation between signals taken by different taps due to various factors. Even for the photo-generated electrons generated by incidence of the same return light, there is a difference between output values of the different taps. This phenomenon has an important impact on the image acquisition or the distance measurement.

In recent years, with the development of semiconductor technology, progress has been made on miniaturization of a distance measurement module for measuring a distance to an object. For example, the distance measurement module can be installed in a mobile terminal such as a so-called smart phone, which is a small-size information processing device having a communication function. With the advancement of technology, the Time of flight (TOF) method is most commonly used in the process of distance or depth information detection. The principle of the TOF is described as follows. A light pulse is continuously emitted to the object, and the light returned from the object is received by a sensor, and the distance to the object is obtained by detecting the flight (round-trip) time of the light pulse. In the TOF technology, a method in which the flight time of the light is directly measured is called the DTOF (direct-TOF) technology. In another method, the emitted light signal is periodically modulated, the phase delay of the reflected light signal relative to the emitted light signal is measured, and the flight time is calculated from the phase delay, which is called the ITOF (Indirect-TOF) technology. According to the different modes of modulation and demodulation, there exists a continuous wave (CW) modulation and demodulation mode and a pulse modulated (PM) modulation and demodulation mode. Further, high precision and high sensitivity of the distance detection can be achieved with the ITOF technology. Therefore, the ITOF technology has been widely used.

In order to achieve efficient measurement results and higher chip integration, the two-tap solution or a solution having more than two taps are used for the distance measurement. The distance information of the target may be obtained by the phase distance measurement method, for example, the simplest two-phase solution, Further, a three-phase solution, a four-phase solution or even a five-phase solution may be used to obtain the distance information. The following description is given by taking the four-phase solution as an example. The exposure is required for at least two times (to ensure the measurement accuracy, the exposure is usually required for four times), in order to complete the acquisition of four phase data and output a frame of depth image. In this case, it is difficult to obtain a higher frame rate. Further, in the process of different taps outputting the information, there is a difference between the results as described above. In order to ensure the result accuracy in the distance measurement or the image acquisition, and in order to ensure the efficient and quick detection for the target information in applications such as the image acquisition or the distance measurement, the efficiency of obtaining detection information has been paid more and more attention. In the image acquisition, whether the detection system can efficiently and quickly process high-quality pictures directly affects the user experience, especially in the field of distance measurement. For example, in the case that the detection device and the detected object have a relative speed, quickly and accurately obtaining and processing the distance data is important. Especially in the case that the detection device is an in-vehicle device, fast and accurately acquiring the distance information is very helpful for users to achieve fully automated driving in the fast driving and ensure the safety of autonomous driving.

Further, based on the four-phase distance measurement solution, different exposure durations for different phases are required to ensure the high efficiency of the distance measurement system. In this case, it is more difficult to obtain a higher information output frame rate. Therefore, there is an urgent need for a solution that can obtain the detection information, and especially in the distance measurement process, can ensure that the detection device has very accurate detection results and has a high dynamic range characteristic, and can ensure that the entire distance measurement device can output results efficiently and quickly.

### SUMMARY

In view of the above, an object of the present disclosure is to provide a detection unit, to solve a technical problem that the existing detection unit is not applied to high-precision and fast detection for multi-target.

In order to achieve the above object, solutions in the embodiments of the present disclosure are provided.

In a first aspect, a detection pixel unit is provided according to an embodiment of the present disclosure. The detection pixel unit includes: a photosensitive module, a processing module, a first circuit and a second circuit, and an information acquiring module. The photosensitive module is configured to receive light emitted by a light source to expose the pixel. The processing module configured to perform the exposure process to obtain an exposure signal. The first circuit and the second circuit are each configured to convert incident light into an electrical signal, where the first circuit is configured to receive a first modulation signal, the second circuit is configured to receive a second modulation signal, and the first circuit and the second circuit are configured to generate respective electrical signals based on the first modulation signal and the second modulation signal. The processing module is further configured to receive a first signal and is electrically connected to the light source to control the light source to emit the light to illuminate a detected object, and the processing module is further electrically connected to the photosensitive module to control the photosensitive module to receive multiple receiving control signals having a same phase or different phases as the light signal emitted by the light source, and acquire electrical signals corresponding to at least one of the receiving control signals having the same phase respectively by the two circuits. The information acquiring module is configured to acquire target information of the detected object according to the electrical signals corresponding to at least one of the receiving control signal having the same phase respectively acquired by the two circuits.

Optionally, the processing module is further configured to receive a second signal and is electrically connected to the photosensitive module so that the photosensitive module acquires electrical signals corresponding to the multiple receiving control signals having different phases respectively by the two circuits. The information acquiring module is configured to acquire the target information of the detected object according to the electrical signals corresponding to the multiple receiving control signals having different phases.

Optionally, the pixel unit is a pixel unit for distance acquisition, and the target information is a target distance information.

In another aspect, a detection device is provided in the present disclosure. The detection device includes a light source, a photosensitive module, a processing module, a first circuit and a second circuit, and an information acquiring module. The light source that is operable to emit light to illuminate a detected object. The photosensitive module is configured to expose the pixel array at a time associated with the light emitted by the light source. The processing module is configured to perform the exposure process to obtain an exposure signal. The first circuit and the second circuit are each configured to convert incident light into an electrical signal, where the first circuit is configured to receive a first modulation signal, the second circuit is configured to receive a second modulation signal, and the first circuit and the second circuit are configured to generate respective electrical signals based on the first modulation signal and the second modulation signal. The processing module is further configured to receive a first signal and is electrically connected to the light source to control the light source to emit the light to illuminate a detected object, and the processing module is further electrically connected to the photosensitive module to control the photosensitive module to receive multiple receiving control signals having a same phase or different phases as the light signal emitted by the light source, and acquire electrical signals corresponding to at least one of the receiving control signals having the same phase respectively by the two circuits. The information acquiring module is configured to acquire target information of the detected object according to the electrical signals corresponding to at least one of the receiving control signal having the same phase respectively acquired by the two circuits.

Optionally, the processing module is further configured to receive a second signal and is electrically connected to the photosensitive module so that the photosensitive module acquires electrical signals corresponding to the multiple receiving control signals having different phases respectively by the two circuits. The information acquiring module is configured to acquire the target information of the detected object according to the electrical signals corresponding to the multiple receiving control signals having different phases.

Optionally, phases of the multiple receiving control signals having the same phase or different phases include 0°, 90°, 180° and 270°.

Optionally, the information acquiring module is configured to acquire the target information of the detected object according to different electrical signals corresponding to each phase of the four receiving control signals respectively obtained by the two circuits.

Optionally, the exposure information has N groups, N is an integer greater than or equal to two, and the N groups of exposures include two groups of exposures respectively having at least a first exposure duration and a second exposure duration, where the first exposure duration is less than the second exposure duration.

Optionally, the exposure information includes two subframes of information, and each of the two subframes of information includes information of four different receiving control phase signals.

Optionally, the two subframes contain a same number of first exposure duration information, and the first exposure duration information includes information of four different receiving control phases.

Optionally, the two subframes further contain a same number of second exposure duration information, and a first subframe contains information corresponding to at least one second exposure duration, and the second exposure duration contains output information corresponding to the receiving control signals of two phases with a phase difference of 180°, the second subframe contains at least one second exposure duration information, and the second exposure duration contains output information corresponding to the receiving control signals of two phases with a phase difference of 180°, and the receiving control signals with a phase difference of 180° in the second exposure duration contained in the two subframes form output signals of the four receiving control signals having different phases.

Optionally, the N groups of exposure information include multiple subframes of information, and each of the multiple subframes of information includes information of four different receiving control phase signals.

Optionally, two adjacent subframes among the multiple subframes each contains output information corresponding to at least one of the receiving control signals of two phases with a phase difference of 180°, and the receiving control signals with a phase difference of 180° in the second exposure duration contained in the two adjacent subframes form output signals of the four receiving control signals having different phases. The processing module is further configured to receive a third control signal and output electrical signals corresponding to at least one of different phase control signals in at least one exposure duration in different subframes respectively by the two circuits. The information acquiring module is configured to acquire the target information of the detected object according to the electrical signals corresponding to the receiving control signals having the same phase acquired respectively by the two circuits.

In a third aspect, a detection method is provided according to an embodiment of the present disclosure. The detection method is applied to the detection device as described in the second aspect. The detection method includes:

emitting, by the light source, light to illuminate the detected object;

exposing, by the photosensitive module, the pixel array at the time associated with the light emitted by the light source;

performing, by the processing module, the exposure process to obtain the exposure signal;

converting, by the first circuit and the second circuit, the incident light into the respective electrical signal, where the first circuit is configured to receive the first modulation signal, the second circuit is configured to receive the second modulation signal, where the first circuit and the second circuit are configured to generate the respective electrical signals based on the first modulation signal and the second modulation signal;

receiving, by the processing module, the first signal to control the photosensitive module to receive the multiple receiving control signals having the same phase or different phases as the light signal emitted by the light source, and acquiring, respectively by the two circuits, the electrical signals corresponding to at least one of the receiving control signals having the same phase; and

acquiring, by the information acquiring module, the target information of the detected object according to the electrical signals corresponding to the receiving control signal of the same phase respectively acquired by the two circuits.

Optionally, the processing module further receives a second signal to acquire, respectively by the two circuits, electrical signals corresponding to the multiple receiving control signals having different phases. The information acquiring module acquires the target information of the detected object according to the electrical signals corresponding to the multiple receiving control signals having different phases.

Optionally, phases of the multiple receiving control signals having the same phase or different phases include 0°, 90°, 180° and 270°.

Optionally, the information acquiring module is configured to acquire the target information of the detected object according to different electrical signals corresponding to each phase of the four receiving control signals respectively obtained by the two circuits.

Optionally, the exposure information has N groups, N is an integer greater than or equal to two, and the N groups of exposures include two groups of exposures respectively having at least a first exposure duration and a second exposure duration, and the first exposure duration is less than the second exposure duration.

Optionally, the N groups of exposure information include multiple subframes of information, and each of the multiple subframes of information includes information of four different receiving control phase signals.

Optionally, two adjacent subframes among the multiple subframes each contains output information corresponding to at least one of the receiving control signals of two phases with a phase difference of 180°, and the receiving control signals with a phase difference of 180° in the second exposure duration contained in the two adjacent subframes form output signals of the four receiving control signals having different phases. The processing module further receives a third control signal and output electrical signals corresponding to at least one of different phase control signals in at least one exposure duration in different subframes respectively by the two circuits. The information acquiring module acquires the target information of the detected object according to the electrical signals corresponding to the receiving control signals having the same phase acquired respectively by the two circuits.

### The Present Disclosure has the Following Beneficial Effects

A detection unit, a detection device and a detection method are provided according to embodiments of the present disclosure. The detection device includes: a light source, a photosensitive module, a processing module, a first circuit and a second circuit, and an information acquiring module. The light source that is operable to emit light to illuminate a detected object. The photosensitive module is configured to expose the pixel array at a time associated with the light emitted by the light source. The processing module is configured to perform the exposure process to obtain an exposure signal. The first circuit and the second circuit are each configured to convert incident light into an electrical signal, where the first circuit is configured to receive a first modulation signal, the second circuit is configured to receive a second modulation signal, and the first circuit and the second circuit are configured to generate respective electrical signals based on the first modulation signal and the second modulation signal. The processing module is further configured to receive a first signal and is electrically connected to the light source to control the light source to emit the light to illuminate a detected object, and the processing module is further electrically connected to the photosensitive module to control the photosensitive module to receive multiple receiving control signals having a same phase or different phases as the light signal emitted by the light source, and acquire electrical signals corresponding to at least one of the receiving control signals having the same phase respectively by the two circuits. The information acquiring module is configured to acquire target information of the detected object according to the electrical signals corresponding to at least one of the receiving control signal having the same phase respectively acquired by the two circuits. In this way, the detection device has an intelligent selection function. In a first mode, the electrical signals corresponding to the receiving control signal of at least one same phase are respectively acquired by the two circuits in the receiving portion. In other words, the completely same emitted light is reflected by the target and received by different circuits, which may be understood as being obtained by different taps and processed in the subsequent circuit. The two electrical signal values of the same signal can be used to perform certain calculations, including taking the difference and other schemes to finally obtain more accurate information, so that the detector has the maximum accuracy improvement in the terms of the quality of the obtained image or the measured distance. By the independent selection or the pattern selection of the system, for example, the first control signal may be selected by a button of the user, or may be generated by the adaptive control. The signal generation based on the adaptive control may be performed based on a relative movement speed between the detected object and the detection device. In a case that the speed is less than a threshold, the accuracy of the information output is focused on in the detection device, to ensure the accuracy of the information of different detected objects in the view field detected by the whole device. Further, the processing module is further configured to receive a second signal and is electrically connected to the photosensitive module so that the photosensitive module acquires electrical signals corresponding to the multiple receiving control signals having different phases respectively by the two circuits. The information acquiring module is configured to acquire the target information of the detected object according to the electrical signals corresponding to the multiple receiving control signals having different phases. In this mode, the system can output information quickly to ensure the safety of the detection system and high user experience.

### BRIEF DESCRIPTION OF THE DRAWINGS

In order to illustrate technical solutions of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagrams showing functional modules of a detection device according to an embodiment of the present disclosure;

FIG. 2 is a schematic diagram showing an operation of a photosensitive module according to an embodiment of the present disclosure;

FIG. 3 is a schematic diagram showing an operation of an information acquiring module according to an embodiment of the present disclosure;

FIG. 4 is a schematic diagram showing timing control according to an embodiment of the present disclosure;

FIG. 5 is a schematic diagram showing timing control according to another embodiment of the present disclosure;

FIG. 6 is a schematic diagram showing a mode with different exposure durations according to an embodiment of the present disclosure;

FIG. 7 is a schematic diagram showing timing control for a subframe with different exposure durations according to an embodiment of the present disclosure;

FIG. 8 is a schematic diagram showing timing control for a subframe with different exposure durations according to another embodiment of the present disclosure;

FIG. 9 is a schematic diagram showing timing control for multiple subframes with different exposure durations according to an embodiment of the present disclosure;

FIG. 10 is a schematic diagram showing timing control for multiple subframes with different exposure durations according to another embodiment of the present disclosure;

FIG. 11 is a schematic diagram showing timing control for multiple subframes with different exposure durations according to another embodiment of the present disclosure;

FIG. 12 is a schematic flowchart showing a detection method according to an embodiment of the present disclosure; and

FIG. 13 is a schematic flowchart showing a detection method according to another embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those of ordinary skill in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

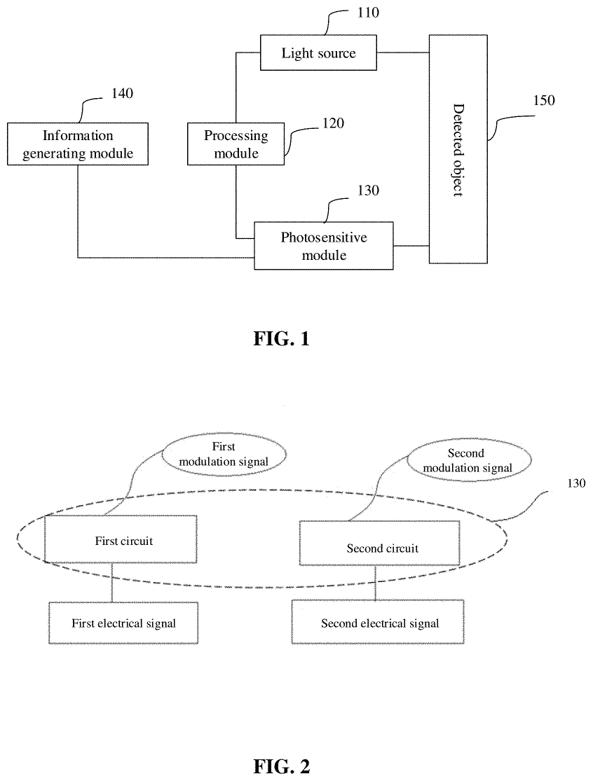

FIG. 1 is a schematic diagram showing functional modules of a detection device according to an embodiment of the present disclosure. As shown in FIG. 1, the detection device includes: a light source 110, a processing module 120, a photosensitive module 130 and an information generating module 140. The light source 110 may be configured as a unit or an array light source system that emits continuous light, which may be implemented by a semiconductor laser, an LED, or other light sources that can be pulsed. In a case that the semiconductor laser is used as the light source, a vertical-cavity surface-emitting laser VCSEL (Vertical-cavity surface-emitting laser) or an edge-emitting semiconductor laser EEL (edge-emitting laser) can be used, which is only exemplary and is not limited herein. Further, the waveform of the light outputted by the light source 110 is not limited herein, which may be a square wave, a triangular wave, a sine wave, or the like. The photosensitive module 130 includes a photoelectric conversion module having a photoelectric conversion function, which may be implemented by a photo-diode (Photo-Diode, PD), which may be specifically a charge-coupled device (Charge-coupled Device, CCD), a complementary metal oxide semiconductor (Complementary Metal Oxide Semiconductor, CMOS), which is not limited herein.

The processing module 120 may include a control module, which may be configured to control the light source to emit the emitted light for different times. When the photosensitive module has phase delays of 0°, 180°, 90° and 270° with the emitted light of the light source 100, the processing module 120 controls the photosensitive module to acquire the light reflected by the detected object 150 corresponding to the different phase delays. The reflected light forms incident light in the photosensitive module 130, and is photoelectrically converted into different information by the receiving portion. In some cases, the 0° and 180° two-phase solution is also used to obtain the information of the detected object. In addition, the acquiring of the target information by the 0°, 120° and 240° three-phase solution is disclosed in some documents, and a five-phase delay solution is disclosed in even some documents, which is not specifically limited in the present disclosure. The acquired target information may be image information of the target, or distance information, contour information, and the like of the target, which is not specifically limited in the present disclosure. In order to illustrate the specific technical problems, the existing problems and solutions are described in detail by taking the four-phase time-of-flight distance acquiring solution as an example. The multi-tap structure may be a structure in which an independent tap is arranged for each phase. Four phase taps are connected to a pixel unit (may be directly connected or connected through an intermediate medium). Alternatively, two phases may share a tap, for example, 0° and 90° share a tap, 180° and 270° share a tap. With this design, not only reliable transmission of information can be achieved, but also the optimization of the pixel size design and layout structure can be ensured. The target information (such as the distance, depth, contour or image) can be efficiently obtained by connecting multiple taps to a pixel.

Based on the above, the light source 110 emits the emitted light, and the photosensitive module 130 is controlled by the processing module 120 to obtain the light reflected from the detected object 150 with a predetermined phase delay, for example, four different phase delays from the emitted light. The reflected light forms incident light in the photosensitive module 130. In this solution, no special requirements are made for the light source, and the light emitted by the light source is the same light each time and there is no phase difference, avoiding the error caused by the adjustment of the luminous state parameters of the light source device during use. Further, the realization of the device is relative simple, which ensures the reliability of the entire detection device system. In this solution, the phase delay is implemented in the receiving portion and the controller. The processing module 120 and/or the information generating module 140 may be integrated in the photosensitive module 130 to ensure the simplicity and efficiency of the system structure. In addition, the multi-phase delay receiving solution is adopted in the receiving portion, avoiding the need to emit light for each phase at the emitting end. For example, in the four-phase solution, target information with two phase delays of 0° and 180° may be acquired by one emission, so that the entire ranging system can achieve the efficient distance measurement. The light emitted by the light source 110 and reflected from the detected object 150 is converted into photo-generated electrons (or photo-generated charges) by a photoelectric conversion module in the photosensitive module 130. Through the modulation by the taps, the photo-generated electrons or charges are transferred inside the device according to a first circuit or a second circuit (where the first circuit or the second circuit mentioned herein includes a charge or electron transfer channel inside the pixel). The photo-generated electrons or charges are respectively transmitted to different external physical circuits via a first electron transfer channel or a second electron transfer channel in the device (where the first circuit or the second circuit further includes a first physical circuit and a second physical circuit outside the pixel). Next, a physical operation (for example, using a charge storage unit, a capacitor, and the like) or a digital operation (for example, integrating a sensor and a computing unit into a chip) is performed in the pixel, or the physical operation or the digital operation is performed in a subsequent ADC circuit or other circuits, which is not limited in the present disclosure.

The following description is given by taking the four-phase two-tap structure as an example. For example, 0° and 90° share one tap, and 180° and 270° share one tap (in a actual operation, sharing a tap does not mean sharing a fixed tap, and the tap shared by the two phase delays may be exchanged with the other). The controller 120 controls the light source 110 to emit the emitted light. After the light is reflected from the detected object 150, the processing module 120 controls the photosensitive module 130 to receive the light with two phase delays, for example, two phase delays of 0° and 180° in the above four-phase solution. The photoelectric conversion module in the photosensitive module 130 converts the light signal with the phase delay into photo-generated electrons in the pixel. The tap of the first circuit receives a first modulation signal to transfer the photo-generated electrons of the 0° phase that are converted by the photoelectric conversion module in the pixel to form an electrical signal, which is outputted by the first circuit. Further, the tap of the second circuit receives a second modulation signal to transfer the photo-generated electrons of the 180° phase that are converted by the photoelectric conversion module in the pixel to form an electrical signal, which is outputted by the second circuit. Alternatively, each phase delay corresponds to one tap. In the first circuit, 0° and 90° share a floating diffusion node (FD), and 180° and 270° share a floating diffusion node (FD). In the actual operation, sharing a floating diffusion node does not mean sharing a fixed floating diffusion node, and the floating diffusion node shared by the two phase delays may be exchanged with the other. In this embodiment, the electrical signals respectively corresponding to the phase delays of 0° and 180° may be obtained in one light source emission. In a next control of the controller, the reception is performed for the two phase delays of 90° and 270° in the four-phase solution, and the photoelectric conversion module in the photosensitive module 130 converts the light signal with the phase delay into photoelectric electrons in the pixel. The tap of the first circuit receives the first modulation signal to transfer the photo-generated electrons of the 90° phase that are converted by the photoelectric conversion module in the pixel to form an electrical signal, which is outputted by the first circuit. Further, the tap of the second circuit receives a second modulation signal to transfer the photo-generated electrons of the 270° phase that are converted by the photoelectric conversion module in the pixel to form an electrical signal, which is outputted by the second circuit. In this case, the information corresponding to 90° and 270° is obtained at one time. Further, the processing module 120 may control the light source 110 to output the emitted light, and control the reception for at least two phase delays of 0° and 180° in the four-phase solution. The photoelectric conversion module in the receiving portion 130 converts the light signal with the phase delay into photoelectric electrons in the pixel. The tap of the first circuit receives the first modulation signal to transfer the photo-generated electrons of the 180° phase that are converted by the photoelectric conversion module in the pixel to form an electrical signal, which is outputted by the first circuit. Further, the tap of the second circuit receives a second modulation signal to transfer the photo-generated electrons of the 0° phase that are converted by the photoelectric conversion module in the pixel to form an electrical signal, which is outputted by the second circuit. In this way, electrical signals corresponding to at least one of receiving control signals having the same phase are respectively obtained by the two circuits. In the final target information operation process, at least two electrical signals obtained by the two circuits may be operated to obtain target information. For example, for image or distance information, the following operations may be performed using the signals obtained by the two circuits.

f(0°)=mf(0°_1)+nf(0°_2)

f(180°)=lf(180°_1)+hf(180°_2) (1)

The results of the phase delays of 90° and 270° are obtained similarly, and may be corrected by an operation similar to the formula 1. The corrected result may be used to obtain the final target information. The corrected result may be an intermediate result and may be directly used in a specific expression of the final image or distance operation, which is not limited in the present disclosure. In the above formula, f(0°) represents a final information result corresponding to the 0° phase that needs to be corrected, f (0°_1) represents an information result corresponding to the 0° phase obtained by the first circuit, and f (0°_2) represents an information result corresponding to the 0° phase obtained by the second circuit, where m, n, l, h each may be a correction coefficient valued in an interval [−1, 1].

In the above embodiment, the receiving phases whose phase delays are respectively 0° and 180° have a phase difference of 180°, the modulation signals corresponding to the first circuit and the second circuit for the two delayed receiving phases are reciprocal signals. That is, in a first time period, the first circuit or the second circuit outputs the electrical signal for the reception of the 0° phase delay, and neither the first circuit nor the second circuit outputs the electrical signal for the reception of the corresponding 180° delay on the pixel, and in another time period, the opposite operation is performed. The similar operation is performed for the receiving phases having a phase difference of 180° whose phase delays are respectively 90° and 270°. In this way, the circuit modulation signals respectively corresponding to the receiving phases having a phase difference of 180° are reciprocal signals, achieving the effect of signal reliability acquisition and system efficient operation while multiple phases share a tap or floating diffusion (FD) node or other circuit components. Phase information with a phase difference of 90° is acquired at a first time interval. This time interval is a self-adjusting time interval inside the system, which may be designed according to a reset sequence to ensure the reliability of the output of different phase signals.

Further, in order to achieve higher detection accuracy, different exposure durations need to be used in the detection of the system, to ensure that there are multiple detected objects 150 in the entire view field and the detected objects have different far-near states. N groups of exposures include a first exposure having a first exposure duration and a second exposure having a second exposure duration. The first exposure is the exposure having a short exposure duration. The two groups of exposures are implemented on the same pixel or pixel array, which can ensure the adaptability of the entire receiving array to the view field, and can avoid a case that the blindness exists due to the receiving array being divided into different units to receive different exposures. Further, the above solution is easier to be achieved in terms of control. The long and short exposures on the same pixel are implemented by using different timings, and a reset control timing is set between the timings, so that there is no interference between different exposure information, and a complex isolation technology is not required at the pixel design level.

In the operation, the detection device may receive a first signal, which may be a selection button signal of a user. For example, when the user selects a smart driving button or a button having a similar function, the first control signal is generated. In this case, in order to ensure the distance measurement precision, the detection device outputs electrical signals corresponding to at least one phase delay signal by different circuits. Performing the above similar operations using the electrical signals can ensure the signal accuracy. In addition, long and short exposure signals are contained in multiple exposures. During the short exposure duration of one of the multiple exposures, the signal output is performed by two channels for all four-phase delay signals, which can not only ensure fast detection of a close-range object in the view field, but also ensure the accuracy of the distance finally obtained by the detection. In the second signal state, in order to ensure the high efficiency of the detection in the system, the signal output is performed by only one circuit for each of the four phases. In this case, the distance of the detected object 150 can be quickly obtained, ensuring the user experience. The second signal may be generated adaptively by the system, which may be related to the far-near state of the detected object 150 and/or the relative movement speed between the detection device and the detected object 150. For example, if the detected object 150 is close to the detection device, the relative movement speed between the detection device and the detected object is fast, which is not limited herein. Further, the detection device may receive a third control signal, which is generated in a similar manner to the first detection signal, which is not repeated herein. The third control signal even can be the same signal as the first control signal. At various detection frequencies such as 15 FPS, 30 FPS or 60 FPS per second, the detection information contains multiple subframes of signals. In this case, different phase delay signals and exposure durations are reasonably configured to achieve information complementarily between two adjacent subframes, ensuring the high precision detection of the detection device without reducing the frame rate of information acquisition, thereby ensuring the high efficiency of the system.

The technical problems and solutions in multi-tap in the TOF distance measurement are further explained below. In a case that the charges are distributed to the first tap and the second tap according to the distance to the target, the depth representing the distance to the target may be calculated by using all eight detections signals (for each phase signal, the electrical signals corresponding to the phase delay are obtained by two circuits). Electrical information of different phases may be outputted by two different circuits, such as the accumulated charge amount signal. In the process of distance acquiring, a phase difference φ of the light signal shuttling between a lidar imaging radar and the target may be calculated based on 4 groups of integral charges. Taking sinusoidal modulated light as an example, the phase difference φ between the echo signal corresponding to the modulated light and the emitted signal is expressed as:

φ=arctan[(Q_{90°}−Q_{270°})/(Q_{0°}−Q_{180°})] (2)

In the above formula 2, Q_{0°}, Q_{90°}, Q_{180°} and Q_{270°} respectively represent electrical signals converted by the receiver circuits corresponding to different phase delays. In combination with the relationship between the distance and the phase difference, the final distance result may be obtained.

d=(c/2)*[1/(2πf)]*φ (3)

In the above formula 3, c represents the speed of light, and f represents the frequency of the laser light emitted by the light source 110. If the light emitted by the light source 110 is a square wave, the following different cases exist, and the final distance information is obtained according to the following calculation method.

In the case of Q_{0°}>Q_{180°} and Q_{90°}>Q_{270°},

$${D}_{c} = \frac{c}{2} * \frac{1}{4 f} * ( \frac{Q \text{?} - Q \text{?}}{( Q \text{?} - Q \text{?} ) + ( Q \text{?} - Q \text{?} )} ) \qquad ( 4 )$$

$$\text{?} \text{indicates text missing or illegible when filed}$$

In the case of Q_{0°}<Q_{180°} and Q_{90°}>Q_{270°},

$${D}_{c} = \frac{c}{2} * \frac{1}{4 f} * ( 2 - \frac{Q \text{?} - Q \text{?}}{( Q \text{?} - Q \text{?} ) - ( Q \text{?} - Q \text{?} )} ) \qquad ( 5 )$$

$$\text{?} \text{indicates text missing or illegible when filed}$$

In the case of Q_{0°}<Q180° and Q_{90°}<Q_{270°},

$$D \text{?} = \text{?} ( 2 + \frac{Q \text{?} - Q \text{?}}{( Q \text{?} - Q \text{?} ) + ( Q \text{?} - Q \text{?} )} ) \qquad ( 6 )$$

$$\text{?} \text{indicates text missing or illegible when filed}$$

In the case of Q_{0°}>Q_{180°} and Q_{90°}<Q_{270°},

$${D}_{c} = \text{?} * ( 4 - \frac{Q \text{?} - Q \text{?}}{( Q \text{?} - Q \text{?} ) - ( Q \text{?} - Q \text{?} )} ) \qquad ( 7 )$$

$$\text{?} \text{indicates text missing or illegible when filed}$$

In the above formulas 4 to 7 for the distance calculation in the case of the square wave, Q_{0°}, Q_{90°}, Q_{180°} and Q_{270°} respectively represent electrical signals converted by the receiver circuits corresponding to different phase delays, c represents the speed of light, and f represents the frequency of the laser light. In addition, in some special cases, the sine wave method is used by some companies to approximately calculate the distance in the case of the square wave. In the four-phase ranging, different circuits (including the charge transfer channel inside the pixel and the physical circuit outside the pixel) output signal results of different phase delays. However, in the actual use, due to the influences of the delay and offset of the column line and comparator, the results respectively obtained by the two circuits for the same phase received signal have differences. For example, the number of inherent deviation electrons with respect to Q_{0°} and Q_{180°} caused due to these influences are respectively ΔQ1 and ΔQ2. In this case, there is actually a certain deviation in the number of electrons obtained with respect to Q_{0°} and Q_{180°}. For example, the electrical signals corresponding to the four phase delays respectively obtained by the first circuit and the second circuit are expressed as follows.

Q_{0°,r1}=Q_{0°+ΔQ}1;Q_{180°,r2}=Q_{180°}+ΔQ2 (8)

In the formula 8, Q_{0°, r1} represents a value of the electrical signal corresponding to the phase delay of 0° that is converted by the first circuit and actually substituted into the distance calculation formula, and Q_{0°} represents an ideal true value obtained without considering the difference between the first circuit and the second circuit under an ideal condition, and ΔQ1 represents a value of a deviation electrical signal generated when the first circuit performs conversion for the phase delay signal of 0°. In addition, in the formula 8, symbols in the electrical signal calculation expression corresponding to the phase delay of 180° represent the similar meaning to those in the expression corresponding to the phase delay of 0°, which are not repeated herein. The value of ΔQ1 may be expressed by a linear function or a high-order function, and may be simulated according to the actual situation. The deviation electrical signal is difficultly acquired in the actual practice. Therefore, under this condition, substituting the actual values of the electrical signals converted for different phases through different phase delays into the distance solving formula causes a certain deviation, resulting in inaccurate final distance calculation. In the solution of the present disclosure, in order to solve the above technical problem, two electrical signal values may be respectively acquired by the first circuit and the second circuit for each of the four different phase delays, and an arithmetic average method (or a similar algorithm) is used to obtain the electrical signal value finally substituted into the expression, which may be expressed as follows:

Q_{0°,r1}=Q_{0°}+ΔQ1;Q_{0°,r2}=Q_{0°}+ΔQ2;Q_{0°,r}=(Q_{0°,r1}+Q_{0°,r2})/2

Q_{180°,r1}=Q_{180°}+ΔQ1;Q_{180°,r2}=Q_{180°}+ΔQ2;Q_{180°,r}=(Q_{180°,r1}+Q_{180°,r2})/2

Q_{90°,r1}=Q_{90°}+ΔQ1;Q_{90°,r2}=Q_{90°}+ΔQ2;Q_{90°,r}=(Q_{90°,r1}+Q_{0°,r2})/2

Q_{270°,r1}=Q_{270°}+ΔQ1;Q_{270°,r2}=Q_{270°}+ΔQ2;Q_{270°,r}=(Q_{270°,r1}+Q_{270°,r2})/2

That is, the signals respectively obtained by the two circuits are summed. By the sum operation, the results outputted from different circuits for the same phase are superimposed. Based on this, the influencing factors ΔQ1 and ΔQ2 are superimposed. Therefore, the difference between the results outputted by different circuits for the same phase is considered, and the result after the superposition is used in the subsequent distance calculation to obtain an accurate distance result, which is illustrated by means of the formula 4 in the case of the square wave detection.

In the case of Q_{0°}>Q_{180°} and Q_{90°}>Q_{270°},

$$D \text{?} = \frac{c}{2} * \frac{1}{4 f} * ( \frac{Q \text{?} - Q \text{?}}{( Q \text{?} - Q \text{?} ) + ( Q \text{?} - Q \text{?} )} ) \qquad ( 10 )$$

$$= \frac{c}{2} * \frac{1}{4 f} * ( \frac{Q \text{?} + \frac{Δ Q 1 + Δ Q 2}{2} - ( Q \text{?} + \frac{Δ Q 1 + Δ Q 2}{2} )}{Q \text{?} + \frac{Δ Q 1 + Δ Q 2}{2} - ( Q \text{?} + \frac{Δ Q 1 + Δ Q 2}{2} ) + Q \text{?} + \frac{Δ Q 1 + Δ Q 2}{2} - ( Q \text{?} + \frac{Δ Q 1 + Δ Q 2}{2} )} )$$

$$\text{?} \text{indicates text missing or illegible when filed}$$

In the above formula 10, the result of the sum operation may be directly used in the final distance acquiring without averaging, and the final accurate distance information may be obtained by accumulating the physical capacitor charges or by the digital operation of the subsequent arithmetic circuit. In the calculation, due to the difference operation of different phases, the offset caused by the column line comparator or the like can be eliminated. Further, The transfer function mismatch caused by the difference of taps and other non-ideal factors can be removed. The offset charge caused by the transfer function mismatch may be classified as a linear or non-linear relationship, and the principle of the offset charge caused by the transfer function mismatch is similar to that of the charge difference caused by the offset, and a solution similar to that the most accurate value is obtained by performing modification using the values obtained by the two channels used in image sensing applications, as shown in the formula 1.

FIG. 2 is a schematic diagram showing a signal transmission and a connection relationship in the photosensitive module 130. The photosensitive module 130 includes a first circuit and a second circuit. The first circuit may receive the first modulation signal. Under the control of this signal, the photo-generated electrons generated by the photoelectric conversion module inside the photosensitive module 130 may be transferred via the first circuit to form a first electrical signal. As described above, the first circuit includes an electron transfer channel inside the pixel unit and a physical circuit outside the pixel unit. The first modulation signal may be a physical device or apparatus in the first circuit, such as a modulation gate. With the modulation signal generated by the controller, different photo-generated electrons are transferred via the first circuit or the second circuit to form a corresponding electrical signal. The basic principle of the second modulation signal acting on the second circuit is similar to that of the first circuit, which is not repeated herein. Further, the same pixel may be connected to more circuits to obtain more electrical signals, which is not repeated herein. The first circuit and the second circuit may be directly connected to the same pixel unit. By the time-division output of the pixel unit, more pixels can detect the detected object, which ensures the accuracy of detection. In addition, multiple such pixels form an entire pixel array, achieving efficient detection and targeted detection, as well as simultaneous detection for multiple targets.

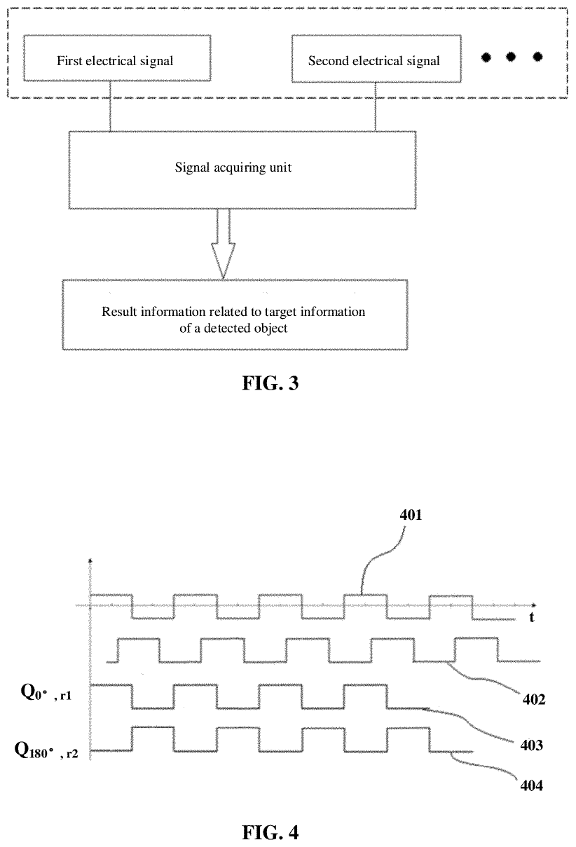

FIG. 3 is a schematic diagram showing that result information of the detected object 150 is acquired by electrical signals obtained by different circuits (two circuits including the first circuit and the second circuit are used as examples for illustration herein, but the specific implementation is not limited to only two circuit output signals). The first electrical signal may include electrical signals outputted by the first circuit respectively corresponding to different phase delays. For example, the first electrical signal may include four electrical signals respectively corresponding to four phase delays of 0°, 90°, 180° and 270°. Similarly, the second electrical signal may include four electrical signals respectively corresponding to four phase delays of 0°, 90°, 180° and 270°. The information generating module 140 acquires the final target information according to electrical signals corresponding to at least one of the receiving control signals having the same phase respectively acquired by the first circuit and the second circuit. The at least one of the receiving control signals having the same phase may be that for any one or more of the above four phases. The four-phase method can be used to realize the high efficiency of the distance measurement. Further, the method shown in the formula 1 may be used to correct the information obtained for at least part of the entire pixel array, to obtain the information required for the calculation of the final target information (such as distance or image). That is, the first electrical signal and the second electrical signal may be used in the calculation process of the final target information, or the final target information may be directly obtained by physical or digital calculation according to the four-phase distance measurement formula described above. The target information of the detected object directly obtained according to the electrical signal obtained by the first circuit or the second circuit is not limited to being directly used for the final calculation.

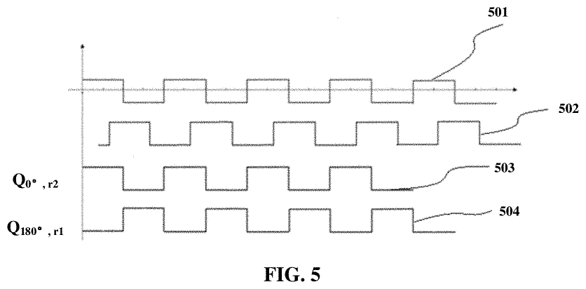

FIG. 4 and FIG. 5 are schematic diagrams showing that the detection is performed by a square emitted light emitted by the light source 110. The following description is given by the two-phase two-tap solution as an example. In FIG. 4 and FIGS. 5, 401 and 501 represent the emitted light emitted by the light source for two times, and 402 and 502 each represent the echo signal obtained after the emitted light is reflected by the target. Further, Q_{0°, r1} represents a first electrical signal corresponding to the phase delay of 0° outputted by the first circuit, Q_{180°, r2} represents a second electrical signal corresponding to the phase delay of 180° outputted by the second circuit, Q_{0°, r2} represents a second electrical signal corresponding to the phase delay of 0° outputted by the second circuit, and Q_{0°, r1} represents a first electrical signal corresponding to the phase delay of 180° outputted by the first circuit. It can be clearly seen from FIG. 4 and FIG. 5 that, the phase delay of 0° refers to the receiver control signal controlled by the controller 130 without any delay from the emitted light, and other phase delays have the similar meaning to that of 0°. The obtained four electrical signals are processed in the information acquiring unit 140, and the final target information may be obtained in the manner described above.

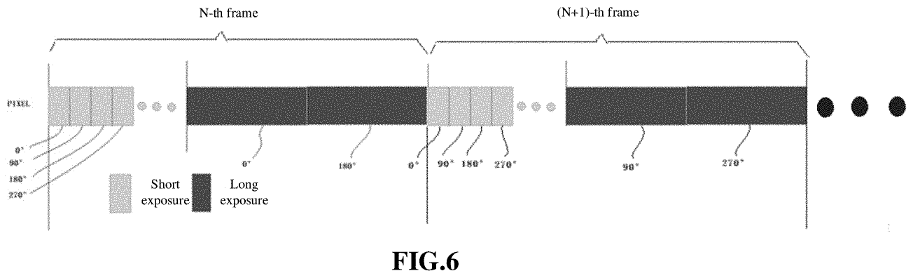

FIG. 6 is a schematic diagram showing setting of different phase delays and different exposure durations in multiple subframes. For example, the frame rate is 15 FPS, 30 FPS or 60 FPS, in other words, each second may contain 15, 30 or 60 subframes. For the four phases of information exposed by different durations in an N-th frame and an (N+1)-th frame, a previous subframe and a latter subframe may form complementary subframes. In this way, in the detection of multiple subframes, the information of the two adjacent subframes can be used for the detection of different distances in a multi-target scenario. Further, the distance information of the detected object can be obtained in the same way as above, such as the four-phase solution. The information of every two adjacent subframes may form complementary information, so that the frame rate of the result output is not reduced due to the large amount of information required to obtain the result.

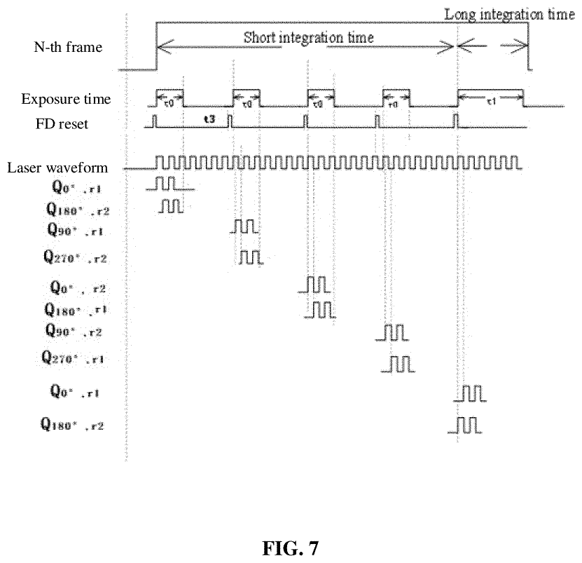

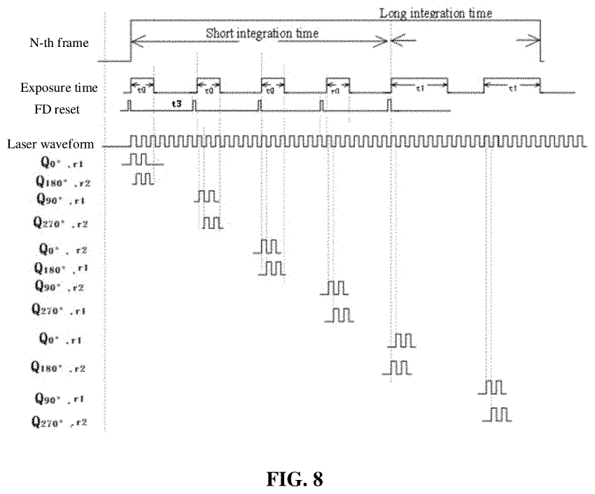

FIG. 7 shows a timing diagram of setting different phases and different exposure duration information. In a current N-th subframe, four-phase data is contained in the short exposure duration, and the result for the phase delay of each short exposure is obtained by the two circuits. In this way, when the detection system is in this mode, the precise distance information of the detected object having the closer distance can be directly obtained in this subframe, eliminating the effects of offset and transfer function mismatch. Further, the result for the long-exposure data of the long-distance detected object can be obtained by the two-phase solution, ensuring that the entire detection can have a higher frame rate.

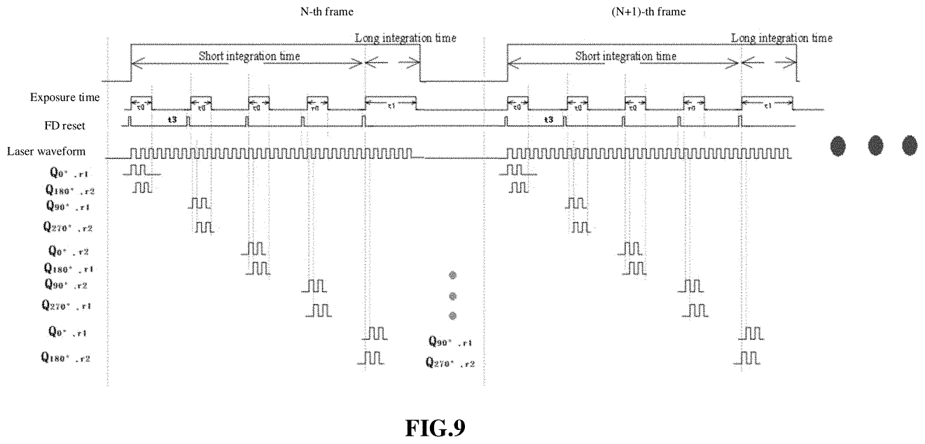

FIG. 8 shows another timing diagram of setting different phases and different exposure duration information. The part in FIG. 8 similar to the setting of FIG. 7 is not repeated. FIG. 8 differs from FIG. 7 in that the phase delay of the long exposure detection corresponding to the long distance is 90° and 270°, which can achieve alternating cooperation with the subframes of FIG. 7, to achieve complementary information at a high frame rate, in order to ensure the output precision and the high efficiency of the output result.

FIG. 9 shows a timing diagram of setting different phases and different exposure duration information in multiple subframes. On the one hand, the high detection accuracy requirement of close-distance detection is considered. Therefore, the result for each phase delay of short-exposure detection is obtained by two circuits, ensuring the user experience and the safety and reliability of the used device. On the other hand, long-exposure information may be arranged in adjacent subframes complementary to each other, ensuring the fast output of the distance measurement result, thereby ensuring that the system works in a higher frame rate mode and improving the user experience.

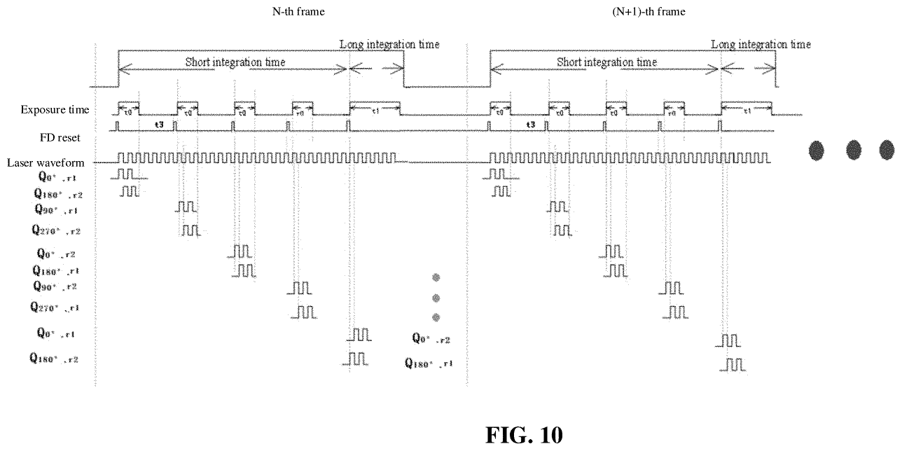

FIG. 10 shows a timing diagram of setting different phases and different exposure duration information in multiple subframes. Compared with the manner in FIG. 9, the complementarity of information of two adjacent subframes is used in the manner shown in FIG. 10, to ensure that the system can work in a high frame rate mode. On the other hand, for the long exposure and long distance, the distance value of the long-distance target is obtained by the two-phase solution, further ensuring that the detection device has a more reliable distance result.

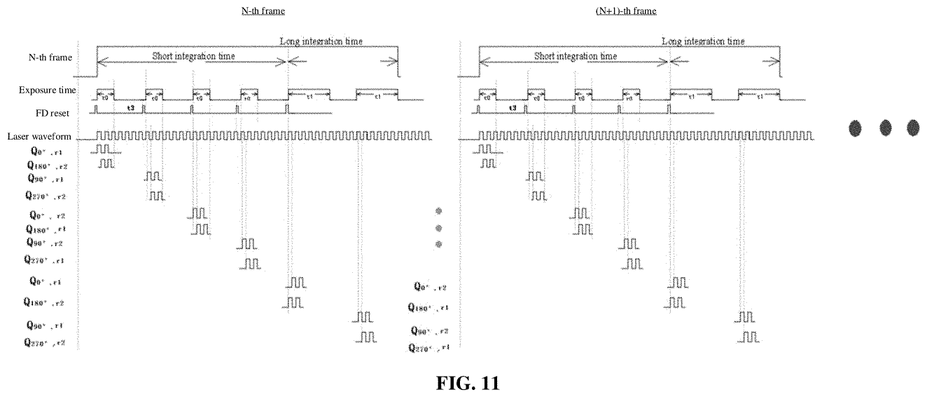

FIG. 11 shows a timing diagram of setting different phases and different exposure duration information in multiple subframes. Compared with the manner in FIG. 10, the results for different phase information of different exposure durations in this mode are each outputted by two different circuits, ensuring that each target in the view field can be efficiently and accurately detected. Further, all the two adjacent subframes of information are complementary with each other, achieving the effect of not reducing the frame rate of the output result in the detection distance.

In the actual use, the arrangement for different exposure durations and different phase delay information acquisition is not limited to those in the above-mentioned examples, which may be reasonably arranged according to the required frame rate. Further, the second exposure duration may be more than four times the first exposure duration, which is not limited herein.

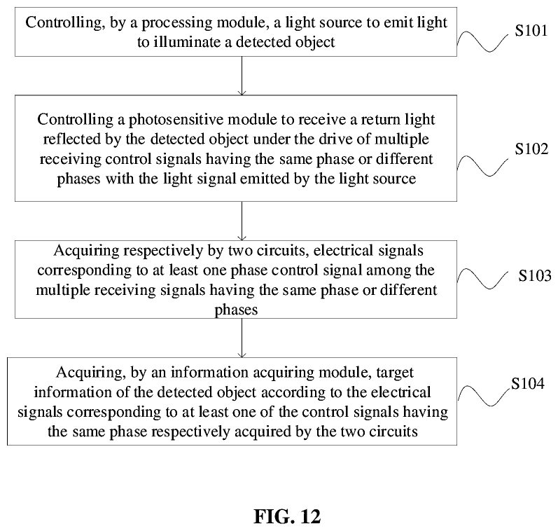

FIG. 12 illustrates steps of a method according to an embodiment of the present disclosure. In S101, the processing module 120 controls the light source 110 to emit light, which may be a square wave, a triangular wave, or a sine wave, or the like, which is not specifically limited herein. The view field is illuminated under the action of the emitted light. The detected object 150 reflects the emitted light to form an echo of a reflected light. In S102, while controlling the light source to emit the emitted light, the processing module 120 controls the photosensitive module 130 to receive the echo of the reflected light by a control signal having a different phase delay from the light source 110. In S103, the photosensitive module 130 acquires electrical signals corresponding to at least one of the multiple receiving signals having the same phase or different phases respectively by the two circuits. The multiple receiving signals having the same phase or different phases indicate that there are multiple delay control signals having the same phase or different phases. For example, the number of the delay control signals for the four-phase delay is four. In S104, the information acquiring module 140 acquires the target information of the detected object 150 according to the electrical signals corresponding to at least one of the control signals having the same phase respectively acquired by the two circuits. The electrical signals corresponding to at least one control signal having the same phase may be used in the middle or final calculation of target information acquisition. The solution of using the electrical signal in a physical or digital manner has also been described before, which is not repeated herein.

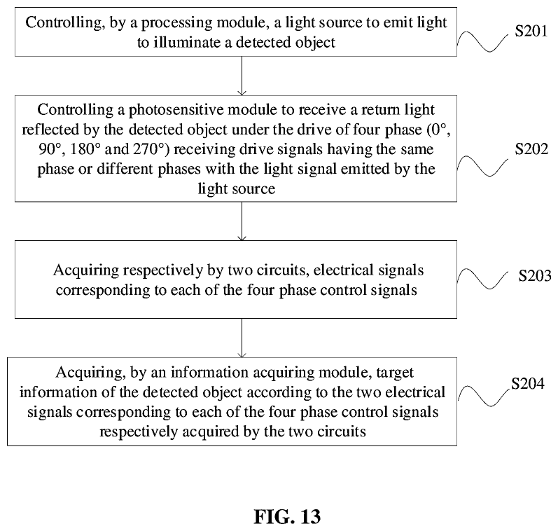

FIG. 13 illustrates steps of a method according to another embodiment of the present disclosure. Similar to the steps shown in FIG. 11, the process of acquiring the target information by using the four-phase solution is further defined in FIG. 13. Further, it is defined that corresponding electrical signals are respectively acquired by the two circuits for each phase of four delay phases, and the implementation of the corresponding steps may refer to the steps in FIG. 7, which is not repeated herein.

It should be noted that, relational terms such as “first” and “second” herein are only used to distinguish one entity or operation from another entity or operation, and do not necessarily require or imply there is such actual relationship or sequence between these entities or operations. Moreover, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a . . . ” does not preclude the presence of additional identical elements in a process, method, article or device including the element.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. A detection pixel unit, comprising:
a photosensitive module configured to receive light emitted by a light source to expose the pixel;
a processing module configured to perform the exposure process to obtain an exposure signal;
a first circuit and a second circuit each configured to convert incident light into an electrical signal, wherein the first circuit is configured to receive a first modulation signal, the second circuit is configured to receive a second modulation signal, wherein the first circuit and the second circuit are configured to generate respective electrical signals based on the first modulation signal and the second modulation signal, and wherein the processing module is further configured to receive a first signal and is electrically connected to the light source to control the light source to emit the light to illuminate a detected object, and the processing module is further electrically connected to the photosensitive module to control the photosensitive module to receive a plurality of receiving control signals having a same phase or different phases as the light signal emitted by the light source, and acquire electrical signals corresponding to at least one of the receiving control signals having the same phase respectively by the two circuits; and
an information acquiring module configured to acquire target information of the detected object according to the electrical signals corresponding to at least one of the receiving control signal having the same phase respectively acquired by the two circuits.

2. The pixel unit according to claim 1, wherein
the processing module is further configured to receive a second signal and is electrically connected to the photosensitive module so that the photosensitive module acquires electrical signals corresponding to the plurality of receiving control signals having different phases respectively by the two circuits; and
the information acquiring module is configured to acquire the target information of the detected object according to the electrical signals corresponding to the plurality of receiving control signals having different phases.

3. The pixel unit according to claim 1, wherein the pixel unit is a pixel unit for distance acquisition, and the target information is a target distance information.

4. An array detection device comprising the pixel according to claim 1, the detection device comprising:
a light source that is operable to emit light to illuminate a detected object;
the photosensitive module configured to expose the pixel array at a time associated with the light emitted by the light source;
the processing module configured to perform the exposure process to obtain an exposure signal;
the first circuit and the second circuit each configured to convert incident light into an electrical signal, wherein the first circuit is configured to receive a first modulation signal, the second circuit is configured to receive a second modulation signal, wherein the first circuit and the second circuit are configured to generate respective electrical signals based on the first modulation signal and the second modulation signal, and wherein the processing module is further configured to receive a first signal and is electrically connected to the light source to control the light source to emit the light to illuminate a detected object, and the processing module is further electrically connected to the photosensitive module to control the photosensitive module to receive a plurality of receiving control signals having a same phase or different phases as the light signal emitted by the light source, and acquire electrical signals corresponding to at least one of the receiving control signals having the same phase respectively by the two circuits; and
the information acquiring module configured to acquire target information of the detected object according to the electrical signals corresponding to at least one of the receiving control signal having the same phase respectively acquired by the two circuits.

5. The detection device according to claim 4, wherein
the processing module is further configured to receive a second signal and is electrically connected to the photosensitive module so that the photosensitive module acquires electrical signals corresponding to the plurality of receiving control signals having different phases respectively by the two circuits; and
the information acquiring module is configured to acquire the target information of the detected object according to the electrical signals corresponding to the plurality of receiving control signals having different phases.

6. The detection device according to claim 4, wherein phases of the plurality of receiving control signals having the same phase or different phases comprise 0°, 90°, 180° and 270°.

7. The detection device according to claim 7, wherein the information acquiring module is configured to acquire the target information of the detected object according to different electrical signals corresponding to each phase of the four receiving control signals respectively obtained by the two circuits.

8. The detection device according to claim 7, wherein the exposure information has N groups, N is an integer greater than or equal to two, and wherein the N groups of exposures comprise two groups of exposures respectively having at least a first exposure duration and a second exposure duration, the first exposure duration is less than the second exposure duration.

9. The detection device according to claim 8, wherein the exposure information comprises two subframes of information, and each of the two subframes of information comprises information of four different receiving control phase signals.

10. The detection device according to claim 9, the two subframes contain a same number of first exposure duration information, and the first exposure duration information comprises information of four different receiving control phases.

11. The detection device according to claim 10, wherein the two subframes further contain a same number of second exposure duration information, and a first subframe contains information corresponding to at least one second exposure duration, and the second exposure duration contains output information corresponding to the receiving control signals of two phases with a phase difference of 180°, the second subframe contains at least one second exposure duration information, and the second exposure duration contains output information corresponding to the receiving control signals of two phases with a phase difference of 180°, and the receiving control signals with a phase difference of 180° in the second exposure duration contained in the two subframes form output signals of the four receiving control signals having different phases.

12. The detection device according to claim 8, wherein the N groups of exposure information comprise a plurality of subframes of information, and each of the plurality of subframes of information comprises information of four different receiving control phase signals.

13. The detection device according to claim 12, wherein
two adjacent subframes among the plurality of subframes each contains output information corresponding to at least one of the receiving control signals of two phases with a phase difference of 180°, and the receiving control signals with a phase difference of 180° in the second exposure duration contained in the two adjacent subframes form output signals of the four receiving control signals having different phases;
the processing module is further configured to receive a third control signal and output electrical signals corresponding to at least one of different phase control signals in at least one exposure duration in different subframes respectively by the two circuits; and
the information acquiring module is configured to acquire the target information of the detected object according to the electrical signals corresponding to the receiving control signals having the same phase acquired respectively by the two circuits.

14. A detection method, performed by the detection device according to claim 4, the detection method comprising:
emitting, by the light source, light to illuminate the detected object;
exposing, by the photosensitive module, the pixel array at the time associated with the light emitted by the light source;
performing, by the processing module, the exposure process to obtain the exposure signal;
converting, by the first circuit and the second circuit, the incident light into the respective electrical signal, wherein the first circuit is configured to receive the first modulation signal, the second circuit is configured to receive the second modulation signal, wherein the first circuit and the second circuit are configured to generate the respective electrical signals based on the first modulation signal and the second modulation signal;
receiving, by the processing module, the first signal to control the photosensitive module to receive the plurality of receiving control signals having the same phase or different phases as the light signal emitted by the light source, and acquiring, respectively by the two circuits, the electrical signals corresponding to at least one of the receiving control signals having the same phase; and
acquiring, by the information acquiring module, the target information of the detected object according to the electrical signals corresponding to the receiving control signal of the same phase respectively acquired by the two circuits.

15. The detection method according to claim 14, wherein
the processing module further receives a second signal to acquire, respectively by the two circuits, electrical signals corresponding to the plurality of receiving control signals having different phases; and
the information acquiring module acquires the target information of the detected object according to the electrical signals corresponding to the plurality of receiving control signals having different phases.

16. The detection method according to claim 14, wherein phases of the plurality of receiving control signals having the same phase or different phases comprise 0°, 90°, 180° and 270°.

17. The detection method according to claim 16, wherein the information acquiring module is configured to acquire the target information of the detected object according to different electrical signals corresponding to each phase of the four receiving control signals respectively obtained by the two circuits.

18. The detection method according to claim 14, wherein the exposure information has N groups, N is an integer greater than or equal to two, and wherein the N groups of exposures comprise two groups of exposures respectively having at least a first exposure duration and a second exposure duration, the first exposure duration is less than the second exposure duration.

19. The detection method according to claim 18, wherein the N groups of exposure information comprise a plurality of subframes of information, and each of the plurality of subframes of information comprises information of four different receiving control phase signals.

20. The detection method according to claim 19, wherein
two adjacent subframes among the plurality of subframes each contains output information corresponding to at least one of the receiving control signals of two phases with a phase difference of 180°, and the receiving control signals with a phase difference of 180° in the second exposure duration contained in the two adjacent subframes form output signals of the four receiving control signals having different phases;
the processing module further receives a third control signal and output electrical signals corresponding to at least one of different phase control signals in at least one exposure duration in different subframes respectively by the two circuits; and
the information acquiring module acquires the target information of the detected object according to the electrical signals corresponding to the receiving control signals having the same phase acquired respectively by the two circuits.
